(19) United States
(12) Patent Application Publication
(10) Pub. No.: US 2004/0231046 A1
(43) Pub. Date: Nov. 25, 2004

(54) NOZZLE HEAD

(76) Inventor: Chin-Tsai Lee, Chang-Hua Hsien (TW)

Correspondence Address: Hsu & Associates, P.O. Box 72, Nankang, Taipei, 115, TW

(21) Appl. No.: 10/444,373

(22) Filed: May 21, 2003

(51) Int. Cl. A47K 3/28

(52) U.S. Cl. 4/615

(57) ABSTRACT

A nozzle head includes a main body, a connector and a covering. The main body provides an annular recess, an annular jut and a wrapped annular end at the periphery of the opening side thereof. The covering is joined to the main body at an inner side thereof and is provided with a bent part at an annular edge thereof being shaped corresponding to the annular recess, the annular jut and the wrapped annular end so as to be fixedly attached to the main body firmly to prevent the covering from being detached from the main body and deformed under pressure in case of the space enclosed by the main body and the covering being filled with water.

### BACKGROUND OF THE INVENTION

1. Field of the Invention

The present invention relates to a nozzle head and particularly to a nozzle head for being used during taking bath in a spa.

2. Description of Related Art

The hydrotherapy such as taking spa bath is getting popular because it is good for the health and in order to enhance the effect of cure, the nozzle head has been designed to have a large sized structure so that greater area of the human body can be sprayed thoroughly. However, the large sized nozzle head has to be subjected to greater pressure once a lot of water is filled in the nozzle head. Hence, it is an important factor has to be considered that if the nozzle head can stand the high pressure in spite of the nozzle head being made of metal. There are two types of metal nozzle heads, which were designed by the inventor, will be mentioned hereinafter.

Referring to FIG. 1, the earliest nozzle head designed by the inventor has a main body 10 and a connector 11 is disposed at the top of the main body 10 for being coupled to a water inlet device. The main body 10 is shaped as a container with the lower side thereof having an annular recess 12 and an annular jut 13. Further, a covering 14 is disposed at the inner side of the main body with the circumferential edge 16 thereof being joined to the junction of the annular recess 12 and the annular jut 13 so that the covering 14 can be retained with the annular recess 12 without detaching from the main body 10. Because the circumferential edge 16 is coated with adhesives for being joined to the main body 10 or welded to the main body 10, the phenomenon of water leakage can be avoided and bonding strength between the covering 14 and the main body 10 can be enhanced. In addition, the covering 14 is fixedly attached with a plurality of nozzles 15 so that the water can be ejected forcedly through the nozzles 15 via the connector.

Referring to FIG. 2, another prior art, which is an improvement on the nozzle head of FIG. 1, developed by the inventor is illustrated. A connecting rod 18 is provided at the center of the connector 11 to pass through the covering 14 and then a fastening head 19 is used for holding the connecting rod 18 to intensify the joining strength between the main body and the covering 14. Of course, the connector 11 at the inner side thereof has a plurality of piercing holes 17 for the water flowing into the nozzle head successfully.

Disadvantages resided in the preceding prior art are explained hereafter.

1. The covering in FIG. 1 is possible to move away the main body to hurt the human body severely due to excessive water pressure.

2. Although the covering in FIG. 2 can prevent from moving away the main body by way of the connecting rod, the covering at the periphery thereof may be deformed with the water pressure to occur water leakage.

The overall structural strength of the prior art is insufficient to resist the excessive water pressure because of weak material being adopted.

### SUMMARY OF THE INVENTION

The crux of the present invention is to rearrange the structure associated with the main body and the covering to remedy the weakness of material and the joint between the main body and the covering is made tightly to avoid the separation of the covering from the main body.

A nozzle head of the present invention has the covering thereof provided with a bent part at the periphery thereof to lap-join with the circumferential edge of the main body. Further, both the main body and the covering have a wrapped rim respectively to coil together such that a reinforced strength for the nozzle head can be obtained and it is capable of keeping contact for the main body and the covering instead of

A primary object of the present invention is to a nozzle head, which has a reinforced structure to prevent the covering thereof from moving away the main body and hurting the human body.

Another object of the present invention is to provide a nozzle head, which provides a firm structure without deformation resulting from great water pressure.

### BRIEF DESCRIPTION OF THE DRAWINGS

The present invention can be more fully understood by reference to the following description and accompanying drawings, in which:

FIG. 1 is a sectional view of a conventional nozzle head;

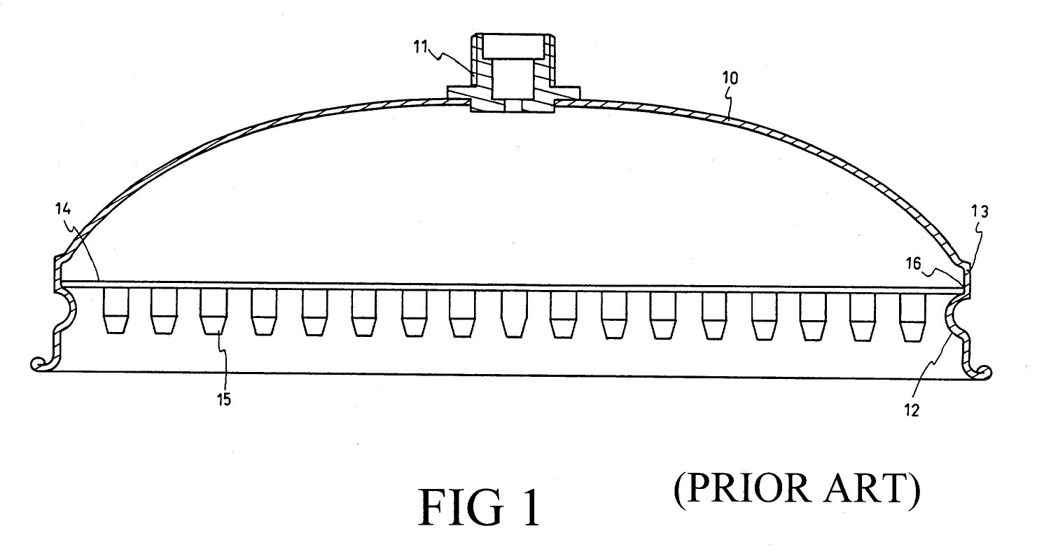

FIG. 2 is a sectional view of another conventional nozzle head; and

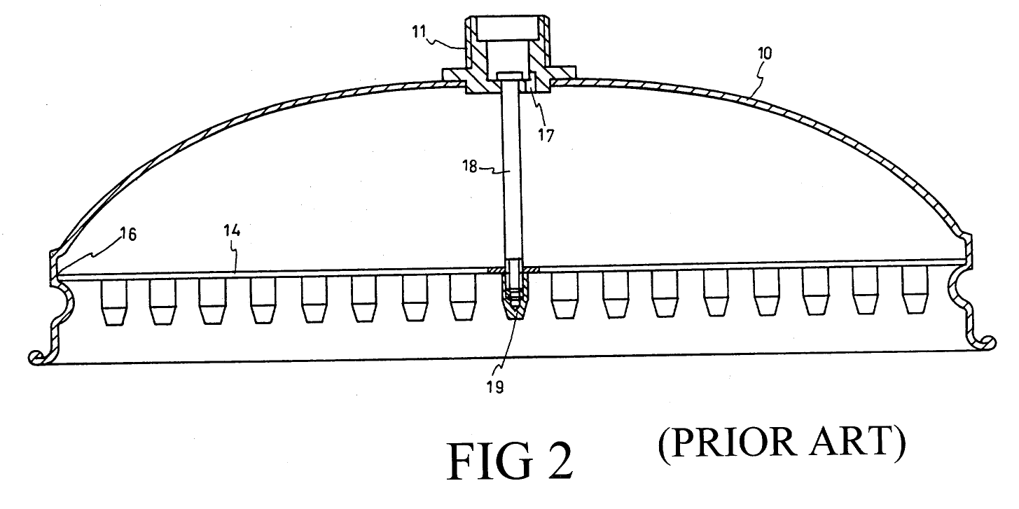

FIG. 3 is a sectional view of a nozzle head according to the present invention.

### DETAILED DESCRIPTION OF THE PREFERRED EMBODIMENT

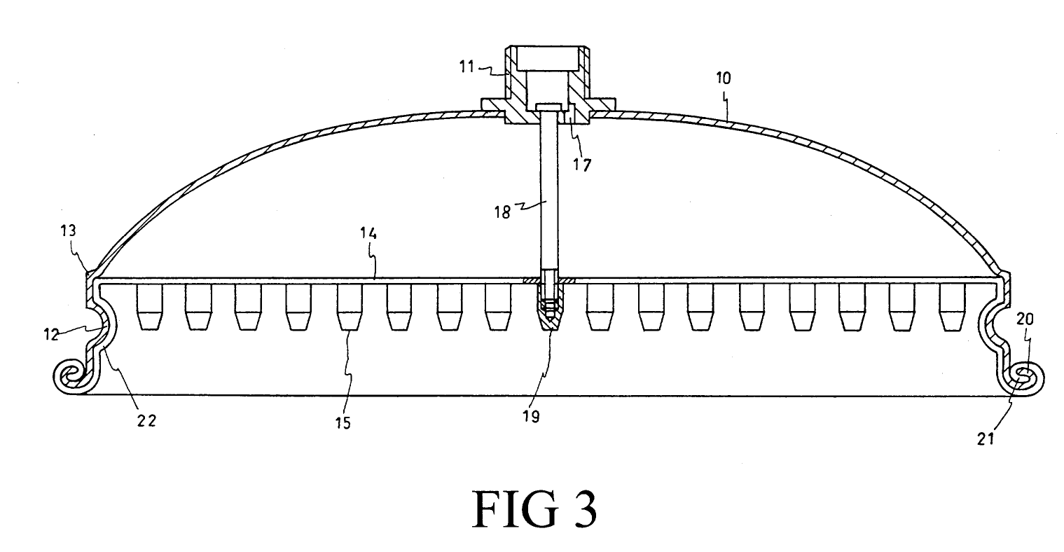

Referring to FIG. 3, basically, a preferred embodiment of the present invention is illustrated. The nozzle head of the present invention includes a main body 10, a connector 11 and a covering 14. The connector 11 is attached to the top of the main body 10 and the main body 10 is shaped as a container with a lower open side. The open side at the periphery thereof is provided with an annular recess 12 and an annular jut 13 with a wrapped rim 20. The covering 14 at the periphery thereof is provided with an annular bent part 22 with a wrapped rim 21 corresponding to the annular recess 12, the annular jut 22 and the wrapped rim 20 so that the covering 14 can fixedly attached to the periphery of the main body 10 firmly. A plurality of nozzles 15 are fixed to the covering 22 and due to the wrapped rims 20, 21 being wrapped and joined consistently, the nozzles 15 are capable of not being deformed because of double layer wrapping structure. Further, due to the annular recess 12, the annular jut 13 and the wrapped rim 20 being joined to the annular bent part 22 tightly, it is not possible to occur separation between the main body 14 and the covering 20.

In addition, a connecting rod 18 can be provided between the connector 11 and the covering 14 to pierce the covering 14 and is secured with a fastening head 19 as the preceding prior art does such that the center of the covering 14 can fixedly joined to the main body to prevent the deformation of the main body at the central area thereof in case of undergoing a great water pressure.

It is appreciated from the foregoing that the nozzle head of the present invention has the following advantages:

1. The nozzle head of the present invention is provided with a double-layer wrapped joint structure to increase the thickness thereof so that it is not liable to occur deformation and a reinforced structure can be obtained.

2. The nozzle head at the covering thereof has a bent part with an annular recess to lap-join with the annular recess at the main body to intensify the capability of resisting deformation.

3. The covering is capable of keeping joining with the main body without occurring phenomenon of separation under impact of water pressure.

4. The nozzle head of the present invention provides strong structure at both the periphery and the central position thereof to prevent from being deformed and leaking.

While the invention has been described with reference to a preferred embodiment thereof, it is to be understood that modifications or variations may be easily made without departing from the spirit of this invention, which is defined by the appended claims.

What is claimed is:

1. A nozzle head, comprising:
a main body, providing an annular recess, an annular jut and a wrapped annular end at a periphery of an opening side thereof;
a connector, being provided at a top of the main body; and
a covering, being joined to the main body at an inner side thereof;
characterized in that the covering is provided with a bent part at an annular edge thereof being shaped corresponding to the annular recess, the annular jut and the wrapped annular end so as to be fixedly attached to the main body firmly to prevent the covering from being detached from the main body.

2. The nozzle head as defined in claim 1, wherein the open side thereof is reinforced with the bent part of the covering.

3. The nozzle head as defined in claim 1, wherein a connecting rod is provided between the main body and a center of the covering and the connecting rod pierces the covering and is fastened to the covering with a plug head.
